(19) United States
(12) Patent Application Publication
(10) Pub. No.: US 2026/0201130 A1
(43) Pub. Date: Jul. 16, 2026

(54) SYSTEMS AND METHODS FOR MANUFACTURING POLYMER FILMS

(71) Applicant: Schlumberger Technology Corporation, Sugar Land, TX (US)

(72) Inventors: Jonathan Robert Hird, Cambridge (GB); Javier Rubio Garcia, Cambridge (GB); Andrew Clarke, Cambridge (GB)

(21) Appl. No.: 19/017,836

(22) Filed: Jan. 13, 2025

(51) Int. Cl. C08J 5/18; C08J 3/24; C08J 3/28

(52) U.S. Cl. CPC C08J 5/18; C08J 3/24; C08J 3/28; C08J 2333/08

(57) ABSTRACT

A method may position a salt-bearing aqueous phase in a vessel. A method may flow a polymer-bearing aqueous phase in the vessel, wherein the polymer-bearing aqueous phase is immiscible with the salt-bearing aqueous phase and forms an aqueous biphasic system (ABS) with an interfacial zone therebetween. A method may position a polymerization initiator in the interfacial zone. A method may activate the polymerization initiator to cross-link polymers of the polymer-bearing aqueous phase. A method may polymerize at least a portion of the interfacial zone to create a polymer film.

### BACKGROUND

Polymer films can have a variety of properties depending on structure, ion concentration, density, and other properties. Producing polymer films with precisely tunable properties, such as porosity and selective molecule passing can simplify and reduce costs for devices in medical fields, refinement processes, and other industrial applications.

### SUMMARY

In some aspects, the techniques described herein relate to a method of manufacturing a polymer membrane, the method including: positioning a salt-bearing aqueous phase in a vessel; flowing a polymer-bearing aqueous phase in the vessel, wherein the polymer-bearing aqueous phase is immiscible with the salt-bearing aqueous phase and forms an aqueous biphasic system (ABS) with an interfacial zone therebetween; positioning a polymerization initiator in the interfacial zone; activating the polymerization initiator to cross-link polymers of the polymer-bearing aqueous phase; and polymerizing at least a portion of the interfacial zone to create a polymer film.

In some aspects, the techniques described herein relate to a method of manufacturing a polymer membrane, the method including: positioning a salt-bearing aqueous phase in a vessel; flowing a polymer-bearing aqueous phase in the vessel, wherein the polymer-bearing aqueous phase is immiscible with the salt-bearing aqueous phase and forms an aqueous biphasic system (ABS) with an interfacial zone therebetween; positioning a polymerization initiator in the interfacial zone; activating the polymerization initiator to cross-link polymers of the polymer-bearing aqueous phase; polymerizing at least a portion of the interfacial zone to create a polymer film; and moving the polymer film from the vessel in a lateral direction relative to the interfacial zone.

In some aspects, the techniques described herein relate to a system for manufacturing a polymer film, the system including: a vessel containing: a polymer-bearing aqueous phase, a salt-bearing aqueous phase, wherein the salt-bearing aqueous phase is immiscible with the polymer-bearing aqueous phase and forms an interfacial zone, and a polymerization activator in the interfacial zone; and an energy source configured to activate the polymerization activator.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and aspects of embodiments of the disclosure will be set forth in the description which follows, and in part will be obvious from the description, or may be learned by the practice of such embodiments. The features and aspects of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, non-schematic drawings should be considered as being to scale for some embodiments of the present disclosure, but not to scale for other embodiments contemplated herein. Understanding that the drawings depict some example embodiments, the embodiments will be described and explained with additional specificity and detail through the use of the accompanying drawings in which:

FIG. 1 is a schematic illustration of a sharp interface between a first fluid phase and a second fluid phase in a fluid system, according to some embodiments of the present disclosure.

FIG. 2 is a schematic illustration of an embodiment of an aqueous biphasic fluid system, according to some embodiments of the present disclosure;

FIG. 3 is a phase diagram of an ABS illustrating biphasic and monophasic regions, according to some embodiments of the present disclosure;

FIG. 4 illustrates graphs of a comparison of interfacial zone thickness by solute concentrations, according to some embodiments of the present disclosure;

FIG. 5 is a flowchart illustrating a method of manufacturing a polymer film having a molecular-selection property, according to some embodiments of the present disclosure;

FIG. 6 is a side cross-sectional view of an ABS with an upper energy source, according to some embodiments of the present disclosure;

FIG. 7 is a side cross-sectional view of an ABS with a lower energy source, according to some embodiments of the present disclosure;

FIG. 8 is a side cross-sectional view of an ABS with total internal reflection (TIR) of the light provided by an energy source, according to some embodiments of the present disclosure;

FIG. 9 is a side cross-sectional view of an ABS including suspended particles located in an interfacial zone, according to some embodiments of the present disclosure; and

FIG. 10 is a side cross-sectional view of a system providing a continuous flow of fluid(s) and a polymer film, according to some embodiments of the present disclosure.

### DETAILED DESCRIPTION

Embodiments of the present disclosure generally relate to devices, systems, and methods for creating polymer films. More particularly, the present disclosure relates to creating molecular-sieve polymer films. In some embodiments, systems and methods according to the present disclosure provide tunable polymer films in a highly scalable production. In some embodiments, systems and methods according to the present disclosure allow for the substantially continuous production of polymer films. In some examples, systems and methods according to the present disclosure allow for the production of large surface area polymer films. In some embodiments, polymer films according to the present disclosure include single-layer polymer films in which a concentration, porosity, or density of the polymer film varies through a thickness of the polymer film.

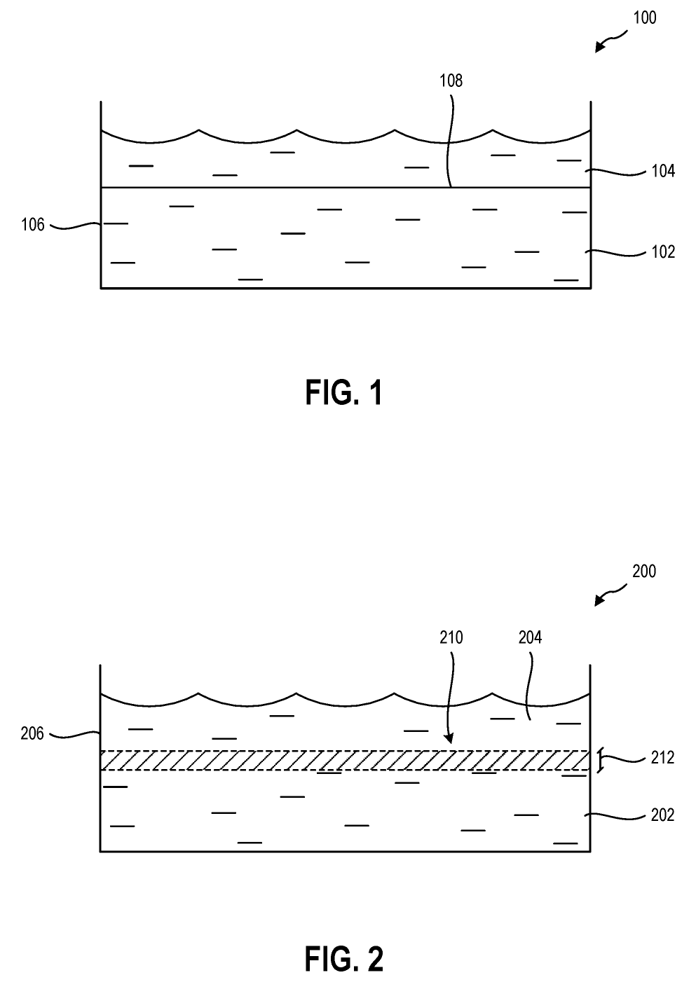

FIG. 1 is a schematic illustration of a sharp interface between a first fluid phase and a second fluid phase in a fluid system 100. In some embodiments, the fluid system 100 includes a first liquid phase 102 and a second liquid phase 104 in a vessel 106 containing the liquid phases. In some embodiments, the first liquid phase 102 and second liquid phase 104 are immiscible, and an interfacial boundary 108 is sharp. For example, the interfacial boundary 108 between two immiscible electrolyte solutions (ITIES)) may be molecularly sharp where none of the first liquid phase 102 is present across the interfacial boundary 108 in the second liquid phase 104 and none of the second liquid phase 104 is present across the interfacial boundary 108 in the first liquid phase 102. However, some biphasic liquid systems have a region between the first liquid phase 102 and the second liquid phase 104 that includes a mixture of both the first liquid phase 102 and the second liquid phase 104.

FIG. 2 is a schematic illustration of an embodiment of an aqueous biphasic fluid system 200. In some embodiments, the aqueous biphasic fluid system 200 includes a first fluid phase 202 and a second fluid phase 204 of liquid containing a solute. The first fluid phase 202 and second fluid phase 204 are contained in a vessel 206 together and separated by an interfacial zone 210 which contains both upper and lower solutes. In some embodiments, across this interfacial zone 210, the concentration of both solutes decreases such that there is a concentration gradient from one phase to the other. In some embodiments, the first fluid phase 202 is or includes a polymer-rich fluid phase and the second fluid phase 204 is or includes a salt-rich fluid phase.

In some embodiments, the interfacial zone 210 has an interfacial thickness 212. The interfacial zone is the region in which both the first and second solutes are present in the liquid. The solutes vary within the interfacial zone 210 from a 100% solute relative concentration of the first solute (relative to the second solute) proximate to the first fluid phase 202 to a 100% relative concentration of the first solute (relative to the first solute). The interfacial thickness 212 is substantially constant across the interfacial zone 210 and/or a polymer film produced therefrom. In some embodiments, the concentration gradient is substantially linear through the interfacial thickness 212. In some embodiments, the concentration gradient is substantially exponential through the interfacial thickness 212. In some embodiments, the concentration gradient is substantially sigmoidal through the interfacial thickness 212.

Various ABSs form when polymers, salts, low-molecular-weight alcohols, and/or ionic liquids are combined over critical concentrations, resulting in the formation of two phases upon de-mixing. Polymer-salt ABSs can be used in applications, such as fractionation, recovery, and purification of proteins, nucleic acids, bionanoparticles, and low-molecular-weight compounds, as well as characterization of proteins and bionanoparticles’ physiochemical properties. Some example polymer-salt ABSs include polyethylene glycol-ammonium sulfate ((NH₄)₂SO₄), polyethylene glycol-sodium sulfate (Na₂SO₄), polyethylene glycol-dipotassium phosphate (K₂HPO₄), polyethylene glycol-monopotassium phosphate (KH₂PO₄), polyethylene glycol-sodium carbonate citrate (Na₂CO₃), etc.

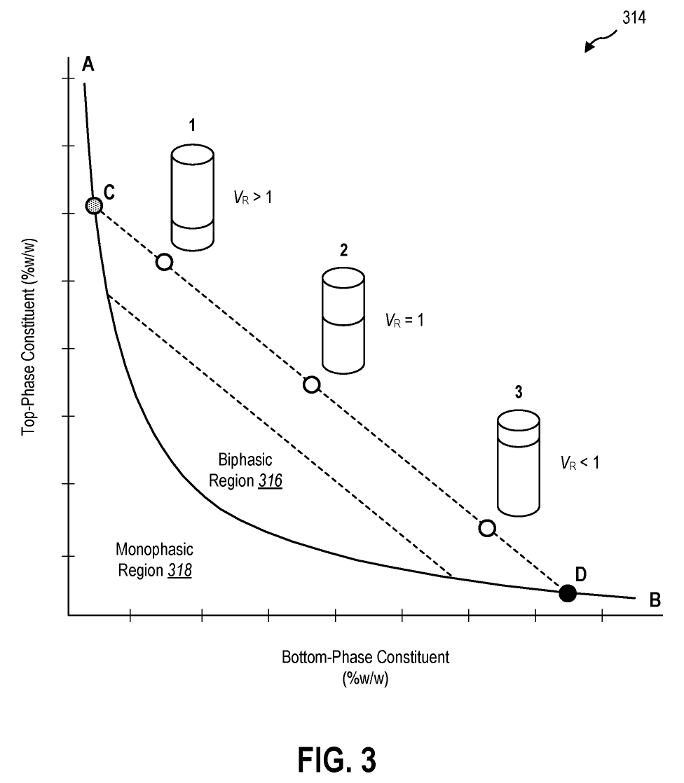

FIG. 3 is a phase diagram 314 of an ABS illustrating biphasic 316 and monophasic regions 318. The biphasic region 316 is located to the right and above the binodal curve. The monophasic region 318 is located to the left and below the binodal curve. In some embodiments, a mixture can have a variety of starting concentrations in each phase of the ABS. The dotted lines (i.e., tie-lines) indicate the amount of the solute that is in each phase, for a given starting mixture, after de-mixing. As the concentration of each phase increases, the system crosses the binodal curve and the mixture becomes biphasic.

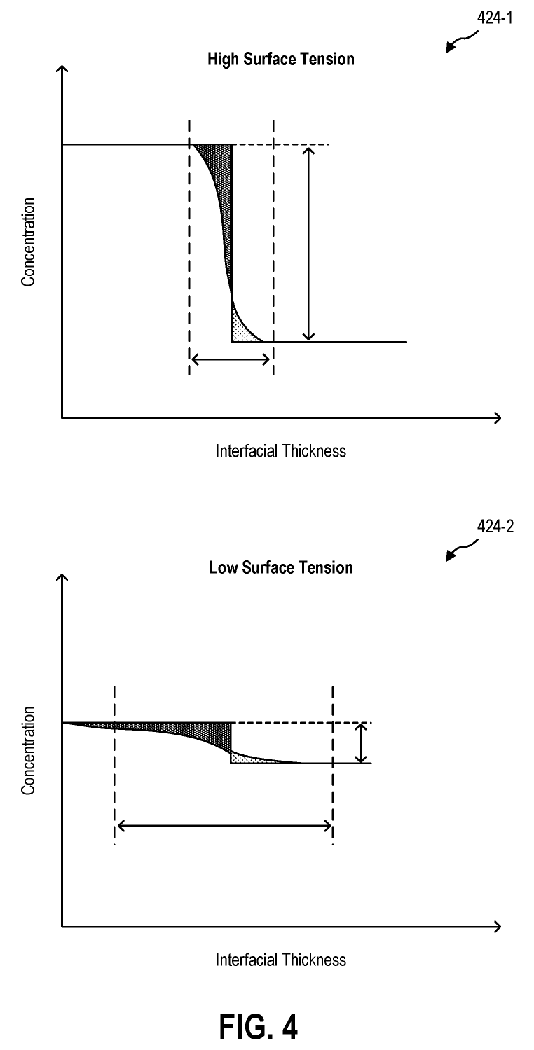

FIG. 4 illustrates graphs 424-1, 424-2 of a comparison of interfacial zone thickness by solute concentrations. In some embodiments of an ABS with immiscible phases, the interfacial zone exhibits a sigmoidal concentration gradient from one phase to the other. In some embodiments, the rate of change of the concentration gradient, the width of the interfacial zone, an equilibrium point in the interfacial zone, and other properties of the interface may be adjusted to alter one or more properties of a polymer film produced from the interfacial zone. In some embodiments, the concentration gradient of the solutes creates a functionally graded membrane, such as a porosity which varies across the thickness of the polymer film. In some examples, such a functionally graded membrane may be selectively designed for molecular-sieve ability. In at least one embodiment, sulfonated isomers are introduced into one of the fluid phases.

In some embodiments, a thickness of the interfacial zone decreases with increasing concentration of the solutes in each of the first polymer-rich fluid phase and a salt-rich fluid phase. For example, the zone thickness may be 11 μm or greater at low concentrations with a lower surface tension, such as illustrated in the second graph 424-2. In some examples, the zone thickness may be 2 μm or less as the concentration of the same solutes is increased, such as illustrated in the first graph 424-1. In some embodiments, the thickness of the interfacial zone is correlated to an interfacial tension between the two phases. A thinner zone exhibits higher interfacial surface tension. In some embodiments, higher interfacial tension is correlated with an increase in molecular selection ability of the fluid mixture at the interfacial zone. A polymer film is, in some embodiments according to the present disclosure, produced from the interfacial zone that retains at least some of the molecular-selection ability of the fluid mixture.

A polymer film is, in some embodiments according to the present disclosure, produced from the interfacial zone that retains at least some of the molecular-selection ability of the fluid mixture. For example, the various properties and applications described herein of liquid ABSs may be retained in a polymer film or hydrogel film produced by the polymerization of the interfacial zone of the ABS. The ABS may then be at least partially stabilized and/or solidified for handling, storage, shipping, or usage in a variety of applications.

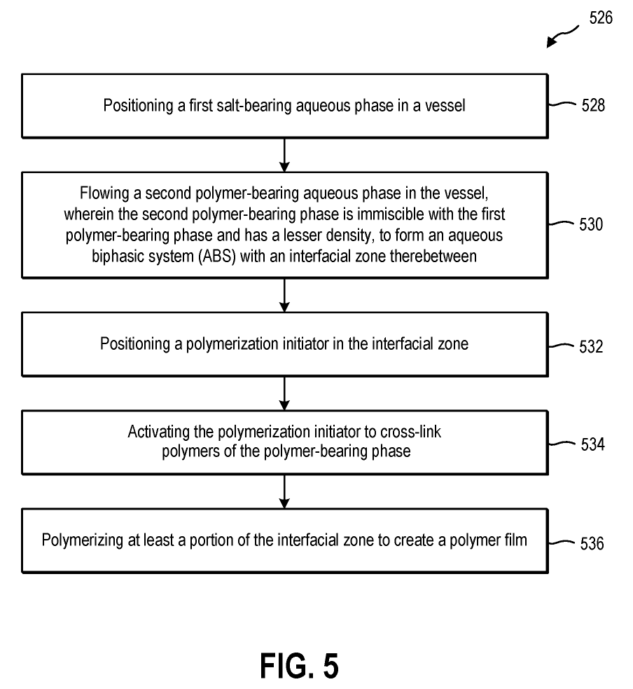

FIG. 5 is a flowchart illustrating an embodiment of a method 526 of manufacturing a polymer film having a molecular-selection property. In some embodiments, the method 526 includes positioning a salt-bearing aqueous phase in a vessel at 528. For example, the salt-bearing aqueous phase may be a fluid phase described in relation to FIG. 2. The method 526 further includes flowing a polymer-bearing aqueous phase in the vessel at 530. In some embodiments, the salt-bearing aqueous phase is immiscible with the polymer-bearing aqueous phase. In some embodiments, the polymer-bearing aqueous phase has a lesser density than the salt-bearing aqueous phase such that the polymer-bearing aqueous phase floats above the salt-bearing aqueous phase. In some embodiments, the polymer-bearing aqueous phase has a greater density than the salt-bearing aqueous phase such that the polymer-bearing aqueous phase settles below the salt-bearing aqueous phase. The polymer-bearing aqueous phase and the salt-bearing aqueous phase form an aqueous biphasic system (ABS) with an interfacial zone therebetween. In some embodiments, at least one of the polymer-bearing aqueous phase and the salt-bearing aqueous phase includes a surfactant.

In some embodiments, flowing the polymer-bearing aqueous phase having a lesser density than the salt-bearing aqueous phase onto the polymer-bearing aqueous phase may allow the polymer-bearing aqueous phase to flow across an upper surface of the salt-bearing aqueous phase with less or substantially no mixing of the fluid phases. In some embodiments, flowing the polymer-bearing aqueous phase includes flowing the polymer-bearing aqueous phase in a substantially laminar flow across the salt-bearing aqueous phase. In some embodiments, flowing the polymer-bearing aqueous phase includes flowing the polymer-bearing aqueous phase underneath the salt-bearing aqueous phase where the polymer-bearing aqueous phase has a density greater than the salt-bearing aqueous phase.

In some embodiments, the upper polymer-bearing aqueous phase is flowed into the vessel such that the interfacial zone thickness is in a range having an upper value, a lower value, or upper and lower values including 1 μm, 2 μm, 4 μm, 6 μm, 8 μm, 10 μm, 12 μm, or any values therebetween. In some examples, the interfacial zone thickness is greater than 1 μm. In some examples, the interfacial zone thickness is less than 12 μm. In some examples, the interfacial zone thickness is between 1 μm and 12 μm. In some examples, the interfacial zone thickness is between 2 μm and 11 μm. In some examples, the interfacial zone thickness is between 4 μm and 10 μm.

In some embodiments, the upper polymer-bearing aqueous phase has an upper phase thickness floating above the interfacial zone in a range having an upper value, a lower value, or upper and lower values including 1 μm, 2 μm, 4 μm, 6 μm, 8 μm, 10 μm, 12 μm, or any values therebetween. In some examples, the upper phase thickness is greater than 1 μm. In some examples, the upper phase thickness is less than 12 μm. In some examples, the upper phase thickness is between 1 μm and 12 μm. In some examples, the upper phase thickness is between 2 μm and 11 μm. In some examples, the upper phase thickness is between 4 μm and 10 μm. In some embodiments, the upper phase thickness is substantially zero. For example, the upper polymer-bearing aqueous phase may flow into the vessel and contact the salt-bearing aqueous phase to form the interfacial zone. In some embodiments, the upper polymer-bearing aqueous phase is only in the interfacial zone.

In some embodiments, the salt-bearing aqueous phase has a lower phase thickness below the interfacial zone in a range having an upper value, a lower value, or upper and lower values including 1 μm, 2 μm, 4 μm, 6 μm, 8 μm, 10 μm, 12 μm, or any values therebetween. In some examples, the lower phase thickness is greater than 1 μm. In some examples, the lower phase thickness is less than 12 μm. In some examples, the lower phase thickness is between 1 μm and 12 μm. In some examples, the lower phase thickness is between 2 μm and 11 μm. In some examples, the lower phase thickness is between 4 μm and 10 μm. In some embodiments, the lower phase thickness is substantially zero. For example, the lower salt-bearing aqueous phase contacts the upper polymer-bearing aqueous phase to form the interfacial zone. In some embodiments, the lower salt-bearing aqueous phase is only in the interfacial zone.

The method 526, in some embodiments, further includes positioning a photopolymerization initiator in the interfacial zone at 532. Photopolymerization initiators generally include three groups. In some embodiments, the photopolymerization initiator generates free radicals upon light irradiation, and the resulting radical starts the polymerization process. In some embodiments, the photopolymerization initiator is a photo-acid generator which produces cations (acid) by light irradiation, which starts the polymerization process of the polymers in the polymer-bearing phase. In some embodiments, the photopolymerization initiator is a photo-base generator, which produces anions (base) by light irradiation to start the polymerization process.

In some embodiments, the photopolymerization initiator is introduced to the polymer-bearing aqueous phase. In some embodiments, the photopolymerization initiator is introduced to the salt-bearing aqueous phase. In some embodiments, the photopolymerization initiator is introduced in both the polymer-bearing aqueous phase and the salt-bearing aqueous phase. In some embodiments, the photopolymerization initiator migrates to the interfacial zone, for example, due to the interfacial tension. In some embodiments, the photopolymerization initiator is soluble in at least one of the polymer-bearing aqueous phase and the salt-bearing aqueous phase. In some embodiments, the photopolymerization initiator will not appreciably change the thermodynamics properties of the fluid system.

In at least one embodiment, the photopolymerization initiator is or includes diphenyl(2,4,6-trimethylbenzoyl)phosphine oxide (hereafter referred to as TPO). In some embodiments, the polymer-bearing aqueous phase is poly(ethylene glycol)-diacrylate (PEGDA) and the salt-bearing aqueous phase is Ammonium Sulfate ((NH₄)₂SO₄). During testing, the TPO is substantially fully partitioned in the upper PEGDA-bearing aqueous phase.

The method 526 further includes, in some embodiments, activating the photopolymerization initiator at 534. In some embodiments, activating the photopolymerization initiator includes energizing the photopolymerization initiator. In some embodiments, energizing the photopolymerization initiator includes directing a source of electromagnetic radiation toward the photopolymerization initiator to provide energy thereto. In some examples, the electromagnetic radiation is visible light. In some examples, the electromagnetic radiation is ultraviolet (UV) light. In some examples, the electromagnetic radiation is infrared (IR) light. In some examples, the electromagnetic radiation is X-ray radiation. In some examples, the electromagnetic radiation is microwave radiation.

In the above example, TPO is a free radical former and, upon photo illuminating the same PEGDA-(NH₄)₂SO₄ ABS, testing has shown that 380 nm light from a light emitted diode (LED) is able to activate the TPO and polymerize the PEGDA upper phase to yield a hydrogel-like material. In another example, an ABS created including a polymer phase such as polyethylene glycol diacrylate or polyvinylpyrrolidone can be cross-linked through the activation of a photopolymerization initiator, such as TPO.

The energy source may irradiate or otherwise provide the energy to the photopolymerization initiator to begin polymerization through a variety of directions and/or methods. In some embodiments, the energy source may be positioned above the interfacial zone. For example, the energy source may be positioned above the vessel or other container of the fluid phase(s) to irradiate downward (relative to a direction of gravity) into the interfacial zone. In some examples, the energy source directs the activating energy through the upper polymer-bearing aqueous phase into the interfacial zone. In some embodiments, the energy source may be positioned below the interfacial zone. For example, the energy source may be positioned above the vessel or other container of the fluid phase(s) to irradiate upward (relative to a direction of gravity) into the interfacial zone. In some embodiments, the energy source directs the activating energy through the lower polymer-bearing aqueous phase into the interfacial zone.

As the activation of the polymerization initiator is based at least partially on the flux of activation energy provided to the polymerization initiator, in some embodiments, the energy source provides diffuse and/or substantially isotropic activation energy with an equal radiant flux per unit area to the fluid system. In some embodiments, the energy source is a substantially uniform source in the direction of the polymerization initiator. In some embodiments, an intermediate fluid phase (e.g., upper aqueous phase when the energy source is above the interface zone or the lower aqueous phase when the energy source is below the interfacial zone) may diffuse the activation energy en route to the interfacial zone. For example, the intermediate fluid phase may scatter at least a portion of the activation energy to diffuse the activation energy across the interfacial zone.

In some embodiments, the activation energy is transmitted to the polymerization initiator indirectly. For example, the activation energy of the polymerization initiator may be an evanescent wave in the interfacial zone that is generated by a total internal reflection (TIR) of light or other EM radiation from the energy source at a boundary between the polymer-bearing aqueous phase and the interfacial zone. For example, the energy source positioned below the ABS may provide light at an incident angle relative to a boundary of the interfacial zone and the salt-bearing aqueous phase to reflect the light with TIR within the salt-bearing aqueous phase. In some embodiments, the TIR at the boundary produces an evanescent wave that propagates into the interfacial zone while substantially no light propagates into the interface zone. In some embodiments, the evanescent wave decays more rapidly than light in the interfacial zone, allowing the penetration depth (and hence the activation depth of the activation of the polymerization activator and associated thickness of a polymer film) to be tuned and/or adjusted.

In some embodiments, the penetration depth of light that is not reflected at the boundary of the interfacial zone, such as with a diffuse energy source, is controlled by a dye or other material in the interfacial zone to attenuate the light. For example, a solute or suspended material in the interfacial zone may attenuate light to limit the penetration depth. In some embodiments, the activation of the polymerization activator is increased by scattering particles in the interfacial zone. For example, a plurality of nanoparticles may be distributed in the interfacial zone (and/or polymer-bearing aqueous phase and/or salt-bearing aqueous phase) to scatter the activation energy and increase the exposure of the polymerization activator to more activation energy.

In some embodiments, the cure time and/or modulation of the activation energy (e.g., light) can also be controlled. For example, an optical mask and/or focused light beam directs the activation energy to some areas in a greater flux than other areas to create structures either onto the films or create free-standing structures. In at least one embodiment, activation energy is applied in a pattern to an upper boundary of the interfacial zone. In at least one embodiment, activation energy is applied in a pattern to a lower boundary of the interfacial zone. In at least one embodiment, activation energy is applied in a pattern to an upper boundary and a lower boundary of the interfacial zone. In such an example, the activation depth may vary at both the upper boundary and lower boundary creating a wave-like polymer film.

The method 526 further includes polymerizing at least a portion of the interfacial zone to create a polymer film at 536. In some embodiments, polymerizing at least a portion of the interfacial zone includes cross-linking polymers from the polymer-bearing aqueous phase. In some embodiments, polymerizing at least a portion of the interfacial zone includes encapsulating at least one particle in the polymer film. In some embodiments, the polymer film maintains at least some of the molecular-sieve property of the interfacial zone of the liquid phase. In some embodiments, the polymer film is a hydrogel film. For example, at least a portion of the polymer-bearing aqueous fluid and/or the salt-bearing aqueous fluid may remain present in the polymer film. In some embodiments, the polymer film is hydrophilic and may absorb and retain additional aqueous fluid.

In some embodiments, polymerizing at least a portion of the interfacial zone includes polymerizing substantially the entire interfacial zone in the vessel. For example, the method 526 may optionally include lifting the polymer film from the vessel with a grid, mesh, tray, or other carrier positioned below the interfacial zone. For example, the grid may be movable upward through the salt-bearing aqueous phase and allow the salt-bearing aqueous phase to flow through the carrier. The carrier may then lift the polymer film from the vessel for removal before the vessel and system are reset to manufacture another polymer film.

In some embodiments, polymerizing at least a portion of the interfacial zone includes polymerizing a region of the interfacial zone that is less than the entire interfacial zone. For example, the method 526 may optionally include sliding the polymer film across the lower aqueous phase (e.g., the salt-bearing aqueous phase) to move the polymer film and expose un-polymerized interfacial zone to an activation zone and polymerize additional fluid and create additional polymer films. In some embodiments, the polymer film is moved substantially continuously relative to the vessel and/or the energy source to polymerize a region of the interfacial zone in a substantially continuous polymer film. In some embodiments, the energy source is moved relative to the vessel and/or the ABS to polymerize a region of the interfacial zone across a large area. For example, a linear energy source may move from a first end of the vessel to a second end of the vessel and progressively polymerize the interfacial zone as the energy source moves across the surface of the ABS.

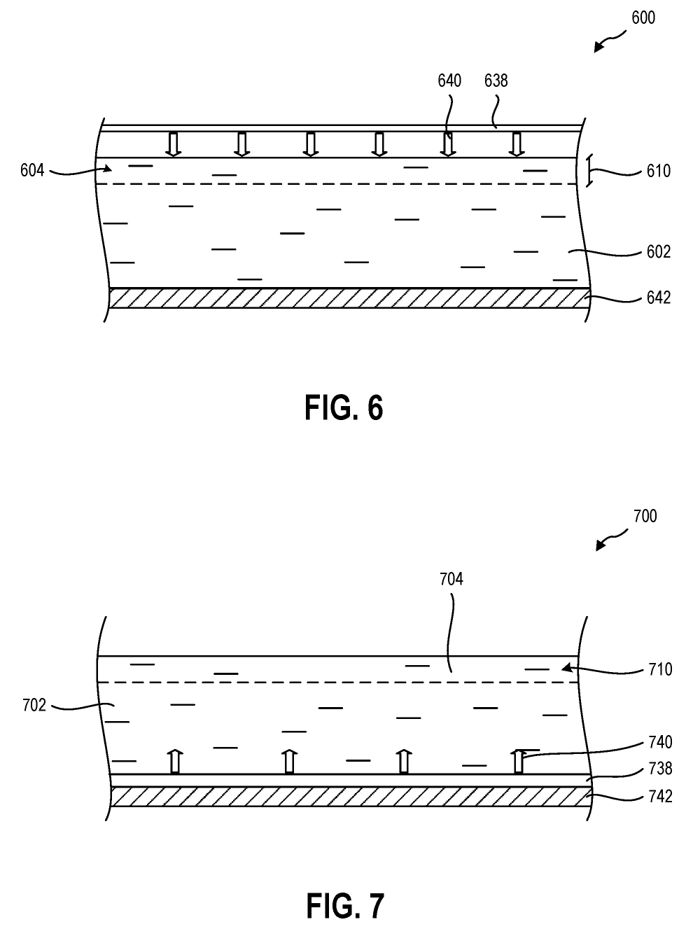

As described herein, the energy source may be located above the ABS. FIG. 6 is a side cross-sectional view of an embodiment of an ABS 600 with an upper energy source 638. In some embodiments, the system 600 includes a vessel 642 into which a salt-bearing aqueous phase 602 is positioned. A polymer-bearing aqueous phase 604 is positioned in the vessel 642 and forms an interfacial zone 610 with the salt-bearing aqueous phase 602. In some embodiments, a portion of the polymer-bearing aqueous phase 604 floats above the interfacial zone 610. In some embodiments, substantially all of the polymer-bearing aqueous phase 604 is within the interfacial zone 610, which may prevent excess polymer-bearing aqueous phase 604 in the system 600 and/or control a thickness of the interfacial zone 610 and/or an associated polymer film created from the interfacial zone 610.

In some embodiments, the energy source 638 provides an activation energy 640 to the interfacial zone 610 in which a polymerization initiator is activated by the activation energy 640. In some embodiments, the activation energy 640 is an electromagnetic radiation. In some examples, the electromagnetic radiation is visible light. In some examples, the electromagnetic radiation is UV light. In some examples, the electromagnetic radiation is IR light. In some examples, the electromagnetic radiation is X-ray radiation. In some examples, the electromagnetic radiation is microwave radiation. In some embodiments, the activation energy 640 is acoustic energy. In some embodiments, the activation energy 640 is thermal energy.

FIG. 7 is a side cross-sectional view of an embodiment of an ABS 700 with a lower energy source 738. In some embodiments, the system 700 includes a vessel 742 into which a first polymer-bearing aqueous phase 702 is positioned. A polymer-bearing aqueous phase 704 is positioned in the vessel 742 and forms an interfacial zone 710 with the salt-bearing aqueous phase 702. In some embodiments, a portion of the polymer-bearing aqueous phase 704 floats above the interfacial zone 710. In some embodiments, substantially all of the polymer-bearing aqueous phase 704 is within the interfacial zone 710, which may prevent excess polymer-bearing aqueous phase 704 in the system 700 and/or control a thickness of the interfacial zone 710 and/or an associated polymer film created from the interfacial zone 710. In some embodiments, the energy source 738 provides the activation energy 740 through the lower (e.g., salt-bearing) aqueous phase 702. In some embodiments, there is substantially no salt-bearing aqueous phase 702 between the energy source 738 and the interfacial zone 710.

In some embodiments, the energy source 738 provides an activation energy 740 to the interfacial zone 710 in which a polymerization initiator is activated by the activation energy 740. In some embodiments, the activation energy 740 is an electromagnetic radiation. In some examples, the electromagnetic radiation is visible light. In some examples, the electromagnetic radiation is UV light. In some examples, the electromagnetic radiation is IR light. In some examples, the electromagnetic radiation is X-ray radiation. In some examples, the electromagnetic radiation is microwave radiation. In some embodiments, the activation energy 740 is acoustic energy. In some embodiments, the activation energy 740 is thermal energy.

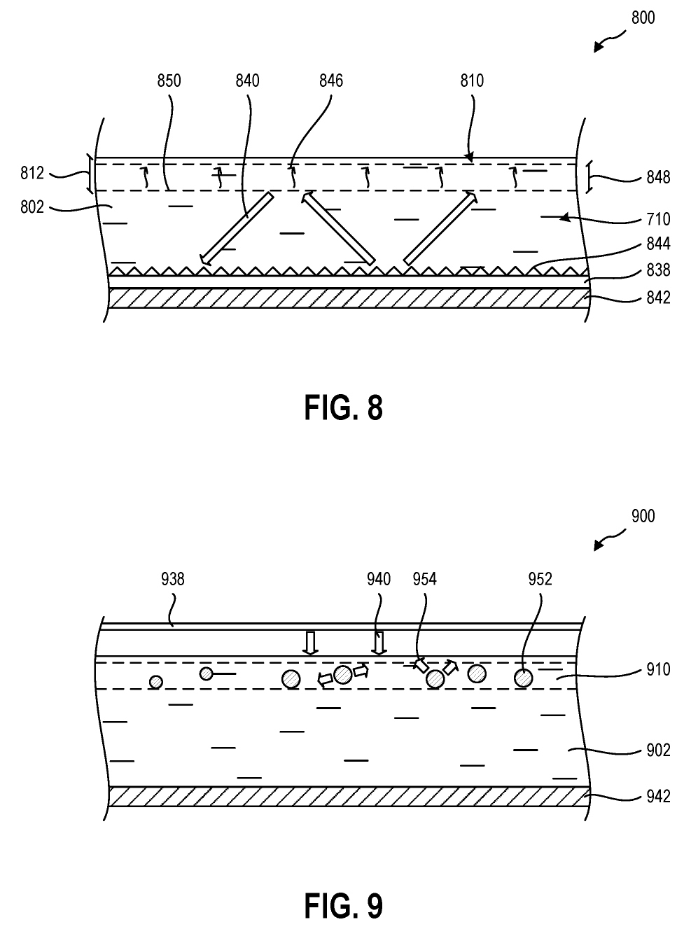

FIG. 8 is a side cross-sectional view of an embodiment of an ABS with total internal reflection (TIR) of the light provided by an energy source 838. In some embodiments, the system 800 includes a vessel 842 into which a salt-bearing aqueous phase 802 is positioned. A polymer-bearing aqueous phase is positioned in the vessel 842 and forms an interfacial zone 810 with the salt-bearing aqueous phase 802. In some embodiments, a portion of the polymer-bearing aqueous phase floats above the interfacial zone 810. In some embodiments, substantially all of the polymer-bearing aqueous phase is within the interfacial zone 810. In some embodiments, the energy source 838 provides the activation energy 840 through the lower (i.e., salt-bearing) aqueous phase 802. In some embodiments, the energy source 838 provides the activation energy 840 through the upper (i.e., polymer-bearing) aqueous phase.

In some embodiments, the energy source 838 provides an activation energy 840 to the interfacial zone 810 in which a polymerization initiator is activated by the activation energy 840. In some embodiments, the activation energy 840 is an electromagnetic radiation that induces an evanescent wave 846 in the interfacial zone 810. In some examples, the electromagnetic radiation is visible light. In some examples, the electromagnetic radiation is UV light. In some examples, the electromagnetic radiation is IR light. In some embodiments, the activation energy 840 is provided at an angle to a boundary 850 of the interfacial zone 810. For example, a grating 844 or other optical element may direct the activation energy 840 toward the boundary 850 at an incident angle. In some embodiments, the angle of the incident activation energy 840 with the boundary 850 induces an activation depth 848 that is based at least partially on the evanescent wave 846 in the interfacial zone 810. In some embodiments, the two phases (e.g., salt-bearing aqueous phase 802 and polymer-bearing aqueous phase) have different refractive indices, and, therefore, there is a Brewster angle of the system. The TIR from the boundary 850 may reflect substantially all of the incident light from the energy source 838, and at least a portion of the activation energy 840 propagates into the interfacial zone via an evanescent wave 846 which minimally penetrates based on the incident angle of the light. Evanescent waves 846 decay rapidly, allowing precise control of small activation depths 848 with the polymerization initiator 812. In some embodiments, activation by an evanescent wave creates a very thin film. It should be understood that while the energy source 838 is illustrated and described as below the interfacial zone 810 in relation to the embodiment of FIG. 8, in some embodiments, the energy source 838 may be located above the interfacial zone 810 and the boundary 850 that reflects the activation energy 840 may be a boundary between the interfacial zone 810 and an upper fluid phase.

FIG. 9 is a side cross-sectional view of an embodiment of an ABS 900 including suspended particles 952 located in an interfacial zone 910. In some embodiments, the suspended particles 952 are located in the interfacial zone 910 and the first polymer-bearing aqueous phase 902. In some embodiments, the suspended particles 952 are located in the interfacial zone 910 and the polymer-bearing aqueous phase. In some embodiments, the suspended particles 952 are located in the interfacial zone 910, the salt-bearing aqueous phase 902, and the polymer-bearing aqueous phase.

The suspended particles 952 may scatter the activation energy 940 to distribute the activation energy 940 within the ABS 900 and within the interfacial zone 910. The scattered energy 954 may provide an isotropic exposure of the interfacial zone 910 to the activation energy 940. In some embodiments, suspended particles are located in the fluid phase after the interfacial zone 910 relative to the energy source 938 to reflect at least a portion of the activation energy back to the interfacial zone. For example, the energy source 938 may be positioned above the interfacial zone 910 and provide activation energy 940 through the interfacial zone 910, where at least a portion of the activation energy 940 enters the salt-bearing aqueous phase 902 below the interfacial zone 910. Suspended particles 952 in the salt-bearing aqueous phase 902 may reflect at least a portion of the activation energy 940 back toward the interfacial zone 910. In at least one embodiment, a polymer film produced in the interfacial zone 910 (such as via polymerization according to one or more methods described herein) may encapsulate at least one suspended particle therein. In some embodiments, the suspended particles are quantum dots. In some embodiments, the suspended particles are gold nanoparticles.

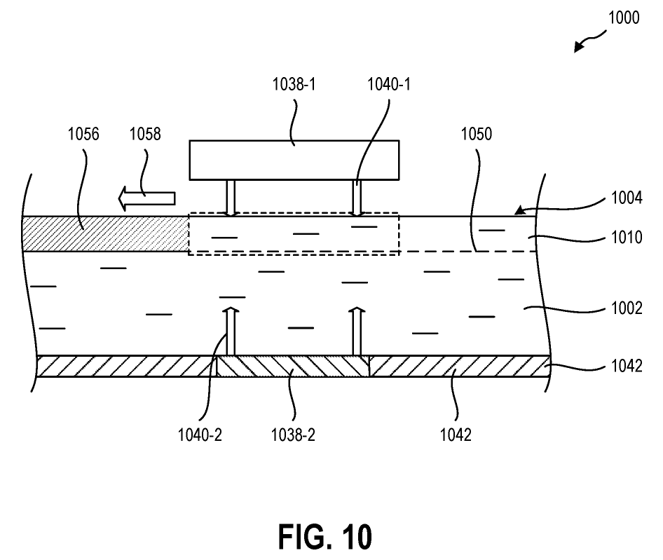

FIG. 10 is a side cross-sectional view of an embodiment of a system 1000 providing a continuous flow of fluid(s) 1002, 1004 and a polymer film 1056. In some embodiments, a salt-bearing aqueous phase 1002 is positioned in a vessel 1042, and a polymer-bearing aqueous phase 1004 is provided to the vessel 1042 to create an interfacial zone 1010 therebetween. In some embodiments, the system 1000 includes an upper energy source 1038-1 and a lower energy source 1038-2 that provide an upper activation energy 1040-1 and a lower activation energy 1040-2, respectively, to an activation zone of the interfacial zone 1010. The activation energy 1040-1, 1040-2 is received by a polymerization initiator in the interfacial zone 1010 and polymerized at least a portion of the interfacial zone 1010 into a polymer film 1056. As described herein, the polymer film 1056 is, in some embodiments, a hydrogel film. The polymer film 1056 moves in a lateral direction 1058 across a boundary 1050 between the polymer film 1056 (and/or the interfacial zone 1010) and the first polymer-bearing aqueous phase 1002 upon which the polymer film 1056 (and/or the interfacial zone 1010) floats.

In some embodiments, as the polymer film 1056 moves in the lateral direction 1058, additional fluid of the ABS is drawn into the activation zone, where the activation energy 1040-1, 1040-2 is received by a polymerization initiator in the activation zone of the interfacial zone 1010 and at least a portion of the interfacial zone 1010 is polymerized into an additional portion of the polymer film 1056. In some embodiments, the lateral movement and polymerization of the polymer film 1056 is substantially continuous to form a substantially continuous polymer film 1056.

In some embodiments, the polymer film 1056 includes cross-linked polymers from the polymer-bearing aqueous phase 1004 (i.e., polymers from the polymer-bearing aqueous phase 1004 cross-linked to other polymers from the polymer-bearing aqueous phase 1004). In some embodiments, salts or other ionic molecules from the salt-bearing aqueous phase 1002 are entrapped by the cross-linked polymers from the polymer-bearing aqueous phase 1004.

It should be understood that the substantially continuous polymerization of a polymer film described in relation to FIG. 10 may be applicable with any embodiment of an ABS and/or energy source described herein. For example, the substantially continuous polymerization of a polymer film described in relation to FIG. 10 may be used with the activation of the polymerization initiator by an evanescent wave described in relation to FIG. 8. In some examples, the substantially continuous polymerization of a polymer film described in relation to FIG. 10 may be used with the suspended particles described in relation to FIG. 9. In some examples, the substantially continuous polymerization of a polymer film described in relation to FIG. 10 may be used with the upper energy source described in relation to FIG. 6. In some examples, the substantially continuous polymerization of a polymer film described in relation to FIG. 10 may be used with the lower energy source described in relation to FIG. 5. In some embodiments, an energy source 1038-1, 1038-2 is movable relative to the vessel 1042 and/or the fluids therein to move in the lateral direction 1058 and polymerize a larger region of the interfacial zone 1010 than an area of the energy source(s) 1038-1, 1038-2.

### INDUSTRIAL APPLICABILITY

Embodiments of the present disclosure generally relate to devices, systems, and methods for creating polymer films. More particularly, the present disclosure relates to creating molecular-sieve polymer films. In some embodiments, systems and methods according to the present disclosure provide tunable polymer films in a highly scalable production. In some embodiments, systems and methods according to the present disclosure allow for the substantially continuous production of polymer films. In some examples, systems and methods according to the present disclosure allow for the production of large surface area polymer films. In some embodiments, polymer films according to the present disclosure include single-layer polymer films in which a concentration, porosity, or density of the polymer film varies through a thickness of the polymer film.

In some embodiments, methods of manufacturing a polymer film include creating an aqueous biphasic system (ABS) including an interfacial zone that exhibits certain chemical or physical properties. A polymer film is, in some embodiments according to the present disclosure, produced from the interfacial zone that retains at least some of the molecular-selection ability of the fluid mixture. For example, the various properties and applications described herein of liquid ABSs may be retained in a polymer film or hydrogel film produced by the polymerization of the interfacial zone of the ABS. The ABS may then be at least partially stabilized and/or solidified for handling, storage, shipping, or usage in a variety of applications.

In some embodiments, a method of manufacturing a polymer film having a molecular-selection property includes positioning a salt-bearing aqueous phase in a vessel. For example, the salt-bearing aqueous phase may be a fluid phase described herein. The method further includes flowing a polymer-bearing aqueous phase in the vessel. In some embodiments, the salt-bearing aqueous phase is immiscible with the polymer-bearing aqueous phase. In some embodiments, the polymer-bearing aqueous phase has a lesser density than the salt-bearing aqueous phase such that the polymer-bearing aqueous phase floats above the salt-bearing aqueous phase. In some embodiments, the polymer-bearing aqueous phase has a greater density than the salt-bearing aqueous phase such that the polymer-bearing aqueous phase settles below the salt-bearing aqueous phase. The polymer-bearing aqueous phase and the salt-bearing aqueous phase form an aqueous biphasic system (ABS) with an interfacial zone therebetween. In some embodiments, at least one of the polymer-bearing aqueous phase and the salt-bearing aqueous phase includes a surfactant.

In some embodiments, flowing the polymer-bearing aqueous phase having a lesser density than the salt-bearing aqueous phase onto the polymer-bearing aqueous phase may allow the polymer-bearing aqueous phase to flow across an upper surface of the salt-bearing aqueous phase with less or substantially no mixing of the fluid phases. In some embodiments, flowing the polymer-bearing aqueous phase includes flowing the polymer-bearing aqueous phase in a substantially laminar flow across the salt-bearing aqueous phase. In some embodiments, flowing the polymer-bearing aqueous phase includes flowing the polymer-bearing aqueous phase underneath the salt-bearing aqueous phase where the polymer-bearing aqueous phase has a density greater than the salt-bearing aqueous phase.

In some embodiments, the upper polymer-bearing aqueous phase is flowed into the vessel such that the interfacial zone thickness is in a range having an upper value, a lower value, or upper and lower values including 1 μm, 2 μm, 4 μm, 6 μm, 8 μm, 10 μm, 12 μm, or any values therebetween. In some examples, the interfacial zone thickness is greater than 1 μm. In some examples, the interfacial zone thickness is less than 12 μm. In some examples, the interfacial zone thickness is between 1 μm and 12 μm. In some examples, the interfacial zone thickness is between 2 μm and 11 μm. In some examples, the interfacial zone thickness is between 4 μm and 10 μm.

In some embodiments, the upper polymer-bearing aqueous phase has an upper phase thickness floating above the interfacial zone in a range having an upper value, a lower value, or upper and lower values including 1 μm, 2 μm, 4 μm, 6 μm, 8 μm, 10 μm, 12 μm, or any values therebetween. In some examples, the upper phase thickness is greater than 1 μm. In some examples, the upper phase thickness is less than 12 μm. In some examples, the upper phase thickness is between 1 μm and 12 μm. In some examples, the upper phase thickness is between 2 μm and 11 μm. In some examples, the upper phase thickness is between 4 μm and 10 μm. In some embodiments, the upper phase thickness is substantially zero. For example, the upper polymer-bearing aqueous phase may flow into the vessel and contact the salt-bearing aqueous phase to form the interfacial zone. In some embodiments, the upper polymer-bearing aqueous phase is only in the interfacial zone.

In some embodiments, the salt-bearing aqueous phase has a lower phase thickness below the interfacial zone in a range having an upper value, a lower value, or upper and lower values including 1 μm, 2 μm, 4 μm, 6 μm, 8 μm, 10 μm, 12 μm, or any values therebetween. In some examples, the lower phase thickness is greater than 1 μm. In some examples, the lower phase thickness is less than 12 μm. In some examples, the lower phase thickness is between 1 μm and 12 μm. In some examples, the lower phase thickness is between 2 μm and 11 μm. In some examples, the lower phase thickness is between 4 μm and 10 μm. In some embodiments, the lower phase thickness is substantially zero. For example, the lower salt-bearing aqueous phase contacts the upper polymer-bearing aqueous phase to form the interfacial zone. In some embodiments, the lower salt-bearing aqueous phase is only in the interfacial zone.

The method, in some embodiments, further includes positioning a photopolymerization initiator in the interfacial zone. Photopolymerization initiators generally include three groups. In some embodiments, the photopolymerization initiator generates free radicals upon light irradiation, and the resulting radical starts the polymerization process. In some embodiments, the photopolymerization initiator is a photo-acid generator which produces cations (acid) by light irradiation, which starts the polymerization process of the polymers in the polymer-bearing phase. In some embodiments, the photopolymerization initiator is a photo-base generator, which produces anions (base) by light irradiation to start the polymerization process.

In some embodiments, the photopolymerization initiator is introduced to the polymer-bearing aqueous phase. In some embodiments, the photopolymerization initiator is introduced to the salt-bearing aqueous phase. In some embodiments, the photopolymerization initiator is introduced in both the polymer-bearing aqueous phase and the salt-bearing aqueous phase. In some embodiments, the photopolymerization initiator migrates to the interfacial zone, for example, due to the interfacial tension. In some embodiments, the photopolymerization initiator is soluble in at least one of the polymer-bearing aqueous phase and the salt-bearing aqueous phase. In some embodiments, the photopolymerization initiator will not appreciably change the thermodynamics properties of the fluid system.

In at least one embodiment, the photopolymerization initiator is or includes diphenyl(2,4,6-trimethylbenzoyl)phosphine oxide (hereafter referred to as TPO). In some embodiments, the polymer-bearing aqueous phase is poly(ethylene glycol)-diacrylate (PEGDA) and the salt-bearing aqueous phase is Ammonium Sulfate ((NH₄)₂SO₄). During testing, the TPO is substantially fully partitioned in the upper PEGDA-bearing aqueous phase.

The method further includes, in some embodiments, activating the photopolymerization initiator. In some embodiments, activating the photopolymerization initiator includes energizing the photopolymerization initiator. In some embodiments, energizing the photopolymerization initiator includes directing a source of electromagnetic radiation toward the photopolymerization initiator to provide energy thereto. In some examples, the electromagnetic radiation is visible light. In some examples, the electromagnetic radiation is ultraviolet (UV) light. In some examples, the electromagnetic radiation is infrared (IR) light. In some examples, the electromagnetic radiation is X-ray radiation. In some examples, the electromagnetic radiation is microwave radiation.

In the above example, TPO is a free radical former and, upon photo illuminating the same PEGDA-(NH₄)₂SO₄ ABS, testing has shown that 380 nm light from a light emitted diode (LED) is able to activate the TPO and polymerize the PEGDA upper phase to yield a hydrogel-like material. In another example, an ABS created including a polymer phase such as polyethylene glycol diacrylate or polyvinylpyrrolidone can be cross-linked through the activation of a photopolymerization initiator, such as TPO.

The energy source may irradiate or otherwise provide the energy to the photopolymerization initiator to begin polymerization through a variety of directions and/or methods. In some embodiments, the energy source may be positioned above the interfacial zone. For example, the energy source may be positioned above the vessel or other container of the fluid phase(s) to irradiate downward (relative to a direction of gravity) into the interfacial zone. In some examples, the energy source directs the activating energy through the upper polymer-bearing aqueous phase into the interfacial zone. In some embodiments, the energy source may be positioned below the interfacial zone. For example, the energy source may be positioned above the vessel or other container of the fluid phase(s) to irradiate upward (relative to a direction of gravity) into the interfacial zone. In some embodiments, the energy source directs the activating energy through the lower polymer-bearing aqueous phase into the interfacial zone.

As the activation of the polymerization initiator is based at least partially on the flux of activation energy provided to the polymerization initiator, in some embodiments, the energy source provides diffuse and/or substantially isotropic activation energy with an equal radiant flux per unit area to the fluid system. In some embodiments, the energy source is a substantially uniform source in the direction of the polymerization initiator. In some embodiments, an intermediate fluid phase (e.g., upper aqueous phase when the energy source is above the interface zone or the lower aqueous phase when the energy source is below the interfacial zone) may diffuse the activation energy en route to the interfacial zone. For example, the intermediate fluid phase may scatter at least a portion of the activation energy to diffuse the activation energy across the interfacial zone.

In some embodiments, the activation energy is transmitted to the polymerization initiator indirectly. For example, the activation energy of the polymerization initiator may be an evanescent wave in the interfacial zone that is generated by a total internal reflection (TIR) of light or other EM radiation from the energy source at a boundary between the polymer-bearing aqueous phase and the interfacial zone. For example, the energy source positioned below the ABS may provide light at an incident angle relative to a boundary of the interfacial zone and the salt-bearing aqueous phase to reflect the light with TIR within the salt-bearing aqueous phase. In some embodiments, the TIR at the boundary produces an evanescent wave that propagates into the interfacial zone while substantially no light propagates into the interface zone. In some embodiments, the evanescent wave decays more rapidly than light in the interfacial zone, allowing the penetration depth (and hence the activation depth of the activation of the polymerization activator and associated thickness of a polymer film) to be tuned and/or adjusted.

In some embodiments, the penetration depth of light that is not reflected at the boundary of the interfacial zone, such as with a diffuse energy source, is controlled by a dye or other material in the interfacial zone to attenuate the light. For example, a solute or suspended material in the interfacial zone may attenuate light to limit the penetration depth. In some embodiments, the activation of the polymerization activator is increased by scattering particles in the interfacial zone. For example, a plurality of nanoparticles may be distributed in the interfacial zone (and/or polymer-bearing aqueous phase and/or salt-bearing aqueous phase) to scatter the activation energy and increase the exposure of the polymerization activator to more activation energy.

In some embodiments, the cure time and/or modulation of the activation energy (e.g., light) can also be controlled. For example, an optical mask and/or focused light beam directs the activation energy to some areas in a greater flux than other areas to create structures either onto the films or create free-standing structures. In at least one embodiment, activation energy is applied in a pattern to an upper boundary of the interfacial zone. In at least one embodiment, activation energy is applied in a pattern to a lower boundary of the interfacial zone. In at least one embodiment, activation energy is applied in a pattern to an upper boundary and a lower boundary of the interfacial zone. In such an example, the activation depth may vary at both the upper boundary and lower boundary creating a wave-like polymer film.

The method further includes polymerizing at least a portion of the interfacial zone to create a polymer film. In some embodiments, polymerizing at least a portion of the interfacial zone includes cross-linking polymers from the polymer-bearing aqueous phase. In some embodiments, polymerizing at least a portion of the interfacial zone includes encapsulating at least one particle in the polymer film. In some embodiments, the polymer film maintains at least some of the molecular-sieve property of the interfacial zone of the liquid phase. In some embodiments, the polymer film is a hydrogel film. For example, at least a portion of the polymer-bearing aqueous fluid and/or the salt-bearing aqueous fluid may remain present in the polymer film. In some embodiments, the polymer film is hydrophilic and may absorb and retain additional aqueous fluid.

In some embodiments, polymerizing at least a portion of the interfacial zone includes polymerizing substantially the entire interfacial zone in the vessel. For example, the method 526 may optionally include lifting the polymer film from the vessel with a grid, mesh, tray, or other carrier positioned below the interfacial zone. For example, the grid may be movable upward through the salt-bearing aqueous phase and allow the salt-bearing aqueous phase to flow through the carrier. The carrier may then lift the polymer film from the vessel for removal before the vessel and system are reset to manufacture another polymer film.

In some embodiments, polymerizing at least a portion of the interfacial zone includes polymerizing a region of the interfacial zone that is less than the entire interfacial zone. For example, the method may optionally include sliding the polymer film across the lower aqueous phase (e.g., the salt-bearing aqueous phase) to move the polymer film and expose un-polymerized interfacial zone to an activation zone and polymerize additional fluid and create additional polymer films. In some embodiments, the polymer film is moved substantially continuously relative to the vessel and/or the energy source to polymerize a region of the interfacial zone in a substantially continuous polymer film. In some embodiments, the energy source is moved relative to the vessel and/or the ABS to polymerize a region of the interfacial zone across a large area. For example, a linear energy source may move from a first end of the vessel to a second end of the vessel and progressively polymerize the interfacial zone as the energy source moves across the surface of the ABS.

As described herein, the energy source may be located above the ABS. In some embodiments, the energy source is located below the ABS. In some embodiments, the system includes a vessel into which a salt-bearing aqueous phase is positioned. A polymer-bearing aqueous phase is positioned in the vessel and forms an interfacial zone with the salt-bearing aqueous phase. In some embodiments, a portion of the polymer-bearing aqueous phase floats above the interfacial zone. In some embodiments, substantially all of the polymer-bearing aqueous phase is within the interfacial zone, which may prevent excess polymer-bearing aqueous phase in the system and/or control a thickness of the interfacial zone and/or an associated polymer film created from the interfacial zone.

In some embodiments, the energy source provides an activation energy to the interfacial zone in which a polymerization initiator is activated by the activation energy. In some embodiments, the activation energy is an electromagnetic radiation. In some examples, the electromagnetic radiation is visible light. In some examples, the electromagnetic radiation is UV light. In some examples, the electromagnetic radiation is IR light. In some examples, the electromagnetic radiation is X-ray radiation. In some examples, the electromagnetic radiation is microwave radiation. In some embodiments, the activation energy is acoustic energy. In some embodiments, the activation energy is thermal energy.

In some embodiments, the energy source provides an activation energy to the interfacial zone in which a polymerization initiator is activated by the activation energy. In some embodiments, the activation energy is an electromagnetic radiation that induces an evanescent wave in the interfacial zone. In some examples, the electromagnetic radiation is visible light. In some examples, the electromagnetic radiation is UV light. In some examples, the electromagnetic radiation is IR light. In some embodiments, the activation energy is provided at an angle to a boundary of the interfacial zone. For example, a grating or other optical element may direct the activation energy toward the boundary at an incident angle. In some embodiments, the angle of the incident activation energy with the boundary induces an activation depth that is based at least partially on the evanescent wave in the interfacial zone. In some embodiments, the two phases (e.g., salt-bearing aqueous phase and polymer-bearing aqueous phase) have different refractive indices, and, therefore, there is a Brewster angle of the system. The TIR from the boundary may reflect substantially all of the incident light from the energy source, and at least a portion of the activation energy propagates into the interfacial zone via an evanescent wave which minimally penetrates based on the incident angle of the light. Evanescent waves decay rapidly, allowing precise control of small activation depths with the polymerization initiator. In some embodiments, activation by an evanescent wave creates a very thin film. It should be understood that while the energy source is described as below the interfacial zone herein, in some embodiments, the energy source may be located above the interfacial zone and the boundary that reflects the activation energy may be a boundary between the interfacial zone and an upper fluid phase.

In some embodiments, an ABS includes suspended particles located in an interfacial zone. In some embodiments, the suspended particles are located in the interfacial zone and the first polymer-bearing aqueous phase. In some embodiments, the suspended particles are located in the interfacial zone and the polymer-bearing aqueous phase. In some embodiments, the suspended particles are located in the interfacial zone, the salt-bearing aqueous phase, and the polymer-bearing aqueous phase.

The suspended particles may scatter the activation energy to distribute the activation energy within the ABS and within the interfacial zone. The scattered energy may provide an isotropic exposure of the interfacial zone to the activation energy. In some embodiments, suspended particles are located in the fluid phase after the interfacial zone relative to the energy source to reflect at least a portion of the activation energy back to the interfacial zone. For example, the energy source may be positioned above the interfacial zone and provide activation energy through the interfacial zone, where at least a portion of the activation energy enters the salt-bearing aqueous phase below the interfacial zone. Suspended particles in the salt-bearing aqueous phase may reflect at least a portion of the activation energy back toward the interfacial zone. In at least one embodiment, a polymer film produced in the interfacial zone (such as via polymerization according to one or more methods described herein) may encapsulate at least one suspended particle therein. In some embodiments, the suspended particles are quantum dots. In some embodiments, the suspended particles are gold nanoparticles.

In some embodiments, a salt-bearing aqueous phase is positioned in a vessel, and a polymer-bearing aqueous phase is provided to the vessel to create an interfacial zone therebetween. In some embodiments, the system includes an upper energy source and a lower energy source that provide an upper activation energy and a lower activation energy, respectively, to an activation zone of the interfacial zone. The activation energy is received by a polymerization initiator in the interfacial zone and polymerized at least a portion of the interfacial zone into a polymer film. As described herein, the polymer film is, in some embodiments, a hydrogel film. The polymer film moves in a lateral direction across a boundary between the polymer film (and/or the interfacial zone) and the first polymer-bearing aqueous phase upon which the polymer film (and/or the interfacial zone) floats.

In some embodiments, as the polymer film moves in the lateral direction, additional fluid of the ABS is drawn into the activation zone, where the activation energy is received by a polymerization initiator in the activation zone of the interfacial zone and at least a portion of the interfacial zone is polymerized into an additional portion of the polymer film. In some embodiments, the lateral movement and polymerization of the polymer film is substantially continuous to form a substantially continuous polymer film.

In some embodiments, the polymer film includes cross-linked polymers from the polymer-bearing aqueous phase (i.e., polymers from the polymer-bearing aqueous phase cross-linked to other polymers from the polymer-bearing aqueous phase). In some embodiments, salts or other ionic molecules from the salt-bearing aqueous phase are entrapped by the cross-linked polymers from the polymer-bearing aqueous phase.

It should be understood that the substantially continuous polymerization of a polymer film described herein may be applicable with any embodiment of an ABS and/or energy source described herein. For example, the substantially continuous polymerization of a polymer film described herein may be used with the activation of the polymerization initiator by an evanescent wave described herein. In some examples, the substantially continuous polymerization of a polymer film described herein may be used with the suspended particles described herein. In some examples, the substantially continuous polymerization of a polymer film described herein may be used with the upper energy source described herein. In some examples, the substantially continuous polymerization of a polymer film described herein may be used with the lower energy source described herein. In some embodiments, an energy source is movable relative to the vessel and/or the fluids therein to move in the lateral direction and polymerize a larger region of the interfacial zone than an area of the energy source(s).

It should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein, to the extent such features are not described as being mutually exclusive. Numbers, percentages, ratios, or other values stated herein are intended to include that value, and also other values that are “about”, “substantially”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. The described embodiments are therefore to be considered as illustrative and not restrictive, and the scope of the disclosure is indicated by the appended claims rather than by the foregoing description.

What is claimed is:

1. A method of manufacturing a polymer membrane, the method comprising:
positioning a salt-bearing aqueous phase in a vessel;
flowing a polymer-bearing aqueous phase in the vessel, wherein the polymer-bearing aqueous phase is immiscible with the salt-bearing aqueous phase and forms an aqueous biphasic system (ABS) with an interfacial zone therebetween;
positioning a polymerization initiator in the interfacial zone;
activating the polymerization initiator to cross-link polymers of the polymer-bearing aqueous phase; and
polymerizing at least a portion of the interfacial zone to create a polymer film.

2. The method of claim 1, wherein the polymerization initiator is a photopolymerization initiator.

3. The method of claim 1, wherein the polymerization initiator is a photo-acid generator.

4. The method of claim 1, wherein the polymerization initiator is a photo-base generator.

5. The method of claim 1, wherein activating the polymerization initiator includes irradiating the polymerization initiator through the salt-bearing aqueous phase and into the interfacial zone.

6. The method of claim 1, wherein activating the polymerization initiator includes irradiating the polymerization initiator through the polymer-bearing aqueous phase and into the interfacial zone.

7. The method of claim 1, wherein activating the polymerization initiator includes exposing the polymerization initiator to an evanescent wave into the interfacial zone from total internal reflection a boundary of the interfacial zone.

8. The method of claim 1, wherein activating the polymerization initiator includes irradiating the polymerization initiator with an activation energy with equal radiant flux per unit area.

9. The method of claim 8, wherein the activation energy is isotropic.

10. The method of claim 1, further comprising optically masking at least a portion of the interfacial zone while activating the polymerization initiator.

11. The method of claim 1, wherein at least one of the polymer-bearing aqueous phase and the salt-bearing aqueous phase includes a sulfonated polymer.

12. The method of claim 1, wherein the interfacial zone includes at least one suspended particle, and the at least one suspended particle is encapsulated by the polymer film.

13. The method of claim 1, further comprising lifting the polymer film from the vessel with a carrier.

14. The method of claim 1, wherein at least one of the polymer-bearing aqueous phase and the salt-bearing aqueous phase includes a surfactant.

15. A method of manufacturing a polymer membrane, the method comprising:
positioning a salt-bearing aqueous phase in a vessel;
flowing a polymer-bearing aqueous phase in the vessel, wherein the polymer-bearing aqueous phase is immiscible with the salt-bearing aqueous phase and forms an aqueous biphasic system (ABS) with an interfacial zone therebetween;
positioning a polymerization initiator in the interfacial zone;
activating the polymerization initiator to cross-link polymers of the polymer-bearing aqueous phase;
polymerizing at least a portion of the interfacial zone to create a polymer film; and
moving the polymer film from the vessel in a lateral direction relative to the interfacial zone.

16. The method of claim 15, further comprising flowing a fluid phase of the interfacial zone in a lateral direction relative to the vessel, and continuously activating the polymerization initiator in an activation zone to polymerize the portion of the interfacial zone.

17. A system for manufacturing a polymer film, the system comprising:
a vessel containing:
a polymer-bearing aqueous phase,
a salt-bearing aqueous phase, wherein the salt-bearing aqueous phase is immiscible with the polymer-bearing aqueous phase and forms an interfacial zone, and
a polymerization activator in the interfacial zone; and
an energy source configured to activate the polymerization activator.

18. The system of claim 17, wherein the energy source is an ultraviolet light source.

19. The system of claim 17, wherein the energy source is movable relative to the vessel.

20. The system of claim 17, wherein the energy source is located below the interfacial zone.
